(19) United States
(12) Patent Application Publication
(10) Pub. No.: US 2015/0065329 A1
(43) Pub. Date: Mar. 5, 2015

(54) METHODS OF MAKING GLASS FROM ORGANIC WASTE FOOD STREAMS

(71) Applicant: Colorado School of Mines, Golden, CO (US)

(72) Inventors: Ivan A. Cornejo, Denver, CO (US); Ivar E. Reimanis, Golden, CO (US); Subramanian Ramalingam, Lakewood, CO (US)

(21) Appl. No.: 14/477,458

(22) Filed: Sep. 4, 2014

Related U.S. Application Data
(60) Provisional application No. 61/873,696, filed on Sep. 4, 2013.

(51) Int. Cl. C03C 3/097; C03C 3/078; C03B 1/00

(52) U.S. Cl. CPC C03C 3/097; C03B 1/00; C03C 3/078
USPC 501/63; 65/134.8; 65/21.5; 65/62; 65/29.11; 501/72

(57) ABSTRACT

The invention introduces new glasses, and new methods for making glass, glass-ceramics, and/or ceramic articles from inorganic compounds extracted from organic waste streams, including food waste streams, agricultural waste streams, and other organic waste streams with high inorganic oxide content. The organic waste stream can also be extended to human and animal wastes. These glasses will have the same, or improved physical, chemical, and mechanical properties as glasses made from mined minerals, however, the methodology disclosed in this invention will produce a renewable and sustainable inorganic product manufactured from organic waste streams.

### CROSS REFERENCE TO RELATED APPLICATIONS

This application claims priority under 35 U.S.C. §119(e) to U.S. Provisional Application Ser. No. 61/873,696, filed on Sep. 4, 2013, which is incorporated herein in its entirety by reference.

### GOVERNMENT INTEREST

This invention was made with government support under grant number DMR-1360565 awarded by the National Science Foundation (NSF). The Government has certain rights in the invention.

### TECHNICAL FIELD

This invention relates to new glass formulations that utilize oxide materials containing organic waste streams, including food waste streams, to supply at least some of the oxide materials that make the batch used to produce the glass. This invention also relates to methods for producing these glass batches, and methods for producing the resultant glasses.

### BACKGROUND

The following text should not be construed as an admission of knowledge in the prior art. Furthermore, citation or identification of any document in this application is not an admission that such document is available as prior art to the present invention, or that any reference forms a part of the common knowledge in the art.

Glass manufacturing has a long history dating back to ancient Mesopotamia. Since then, the process of making glass and glass related products has developed into a complex mix of formulation chemistry, metallurgy, material science, engineering and art. Although glasses can be made by a wide variety of methods, the vast majority is still produced by the melting of batch components at elevated temperatures. Bulk commercial batches are typically formulated from naturally occurring minerals that are mined from the earth. Batch components can be divided into five categories based on their role in the process: glass former, flux, property modifier, colorant, and fining agent.

The most essential component of any glass batch is the glass former. Every glass contains one or more components that serve as the primary source of the structure. The primary glass formers in commercial oxide glasses are silica (SiO₂), boric oxide (B₂O₃), and phosphoric oxide (P₂O₅). A large number of other compounds may act as glass formers, including GeO₂, Bi₂O₃, As₂O₃, Sb₂O₃, TeO₂, Al₂O₃, Ga₂O₃, and V₂O₃. However, the vast bulk of commercial glasses are based on silica as the glass former. The production of silicate glasses typically requires the addition of a flux to reduce the processing temperature to within practical limits, e.g. <1650° C. The most common fluxes are the alkali oxides, especially soda (Na₂O) and PbO. Potassium and lithium oxides are also often used. However, while the addition of fluxes to silica lead to decreased cost of glass formation, the addition of large amounts of alkali oxides results in substantial degradation of many desirable glass properties. This degradation is often counter-acted by the addition of property modifiers, which include the alkaline earth, transition metal oxides, and alumina. It is also possible to produce alumina-rich glass. Alumina-rich glasses and the methods for making the same has been disclosed, in application Ser. No. 14/283,510, filed May 21, 2014, which is incorporated in its entirety by reference.

Typical industrial glass batches obtain their different components from naturally occurring mined minerals: e.g. feldspars for sodium oxide, aluminum oxide, silicon oxide and calcium-oxide, dolomite for calcium and magnesium oxides, fluorspar for calcium, limestone or lime (CaO), potash (KOH), kyanite for alumina and silica, and sand for silica, etc.

However, waste materials are also used in glass batches. The most common example of a waste material used in glass batch formulations is recycled glass called cullet, wherein the cullet supplies recycled oxides to make new glasses. The use of cullet reduces the energy requirements to make the new glass, because the cullet is already in the form of a glass and does not need to be converted from the natural mined mineral form to a molten melt. In certain segments of industry, about 20-30% of new glasses manufactured consist of cullet. However, in most cases, new minerals are mined, sized, purified, and transported from different parts of the world to the glass manufacturing facilities, resulting in raw material costs that account for between about 20-30% of the total cost to manufacture the glasses.

Thus, there is clearly a need in the glass industry for innovative ways to recycle and reuse cheaper materials for producing less expensive glass batches and their resultant glasses. Various examples exist in the field wherein various waste streams are recycled to make glasses. For example, U.S. Pat. No. 5,772,126, which is incorporated by reference in its entirety, describes recycling waste glass fiber from fiber manufacturing processes. Other examples of recycled waste for use in glass batch formulations include the use of asbestos, sludge, ash and filter dust as disclosed in European Patent No. 373557, and fly ash as disclosed in European Patent No. 608257, which are incorporated by reference in their entirety. PCT Application Publication No. 2013/084173, which is incorporated by reference in its entirety, describes recovering stone wastes (e.g. from cutting and polishing processes) to be used as oxide raw materials in glass batch formulations. U.S. Pat. No. 4,874,153, which is incorporated by reference in its entirety, describes the use of sludge obtained from sewage treatment to produce ceramic materials.

However, there is not a process that recycles and utilizes the metal oxides present in common organic wastes, such as food waste, agricultural waste, animal waste, and human waste to purposely make a glass, glass-ceramic, and a ceramic. In industrialized countries the amount of organic waste produced is increasing dramatically each year. Although many gardening enthusiasts ‘compost’ some of their kitchen and garden waste, much of the household waste goes into landfill sites and is often the most hazardous waste. The organic waste component of landfill is broken down by microorganisms to form a liquid ‘leachate’ which contains bacteria, rotting matter and possibly chemical contaminants from the landfill. This leachate can present a serious hazard if it reaches a watercourse or enters the water table. Digesting organic matter in landfills also generates methane, which is a harmful greenhouse gas, in large quantity. Alternative methods and outlets for these common organic wastes are needed.

Organic waste can potentially provide at least some of the inorganic compounds required to produce glass products. The inorganic compounds contain metal oxides and non-metal oxides that, herein may also be referred to as inorganic oxides. The terms inorganic compounds, metal- and non-metal oxides, and inorganic oxides may be used interchangeably herein. Thus, glass manufacturing processes provide a uniquely suited potential route to recycle and reuse these organic wastes, producing useful glass products and reducing the influx of waste into landfills. In other words, to create a sustainable glass manufacturing process.

A typical glass formulation requires silica, alumina, soda, lime, and potash minerals. To minimize the optical attenuation of a glass window, container, and/or glass fiber, usually highly processed and fairly pure minerals are needed (depending on the application). However, the cost of a glass article increases dramatically as a function of the purity of the raw material used.

Food waste is the single-largest waste stream, by weight, in the United States. According to a U.S. EPA report from 2002, Americans discard about 43.6 million tons of food waste each year. As a specific example, the U.S. food industry generates about 150,000 tons of eggshells per year. A calcined eggshell is about 98.6% CaO with small traces of MgO, K₂O, and Na₂O, all ingredients used in glass making. Another food waste example is rice husks. In 2009, the production of rice paddy was 678 million tons worldwide. Each ton of rice paddy produces about 0.2 tons of rice husks. Therefore, in 2009 136 million tons of rice husk were produced. Rice husk is about 20% silica and about 80% carbon. Therefore, the 136 million tons of rice husk produced in 2009 had the potential to produce almost 30 million tons of silica for glass making. This figure represents nearly all of the silica needed for the production of flat glass worldwide. Another source of is wheat husk. In 2010, world production of wheat was 651 million tons, making it the third most produced cereal after maize (844 million tons) and rice (672 million tons). Other food containing rich amounts of inorganic oxides are bananas peels, sunflower hulls, sundried tomatoes, corn husk and cobs, tea, coffee, avocado peels and nuts, peanut shells, etc.

Thus, it is clearly evident that there is a need for glass batch formulations that utilize common inorganic oxide-containing organic wastes, methods for preparing and processing these batch formulations, and methods for producing glasses, glass-ceramics, and ceramics using these organic waste-derived batch formulations.

### SUMMARY OF THE DISCLOSURE

The invention introduces new glasses, and new methods for making glass, glass-ceramics, and/or ceramic articles from inorganic oxides extracted from organic waste streams, including food waste streams, agricultural waste streams, and other organic waste streams with high inorganic oxide content. The organic waste stream can also be extended to human and animal wastes. These glasses will have the same, or improved physical, chemical, and mechanical properties as glasses made from mined minerals, however, the methodology disclosed in this invention will produce a renewable and sustainable inorganic product manufactured from organic waste streams.

It is therefore an objective of this disclosure to provide glass batch formulations that utilize and provide an outlet for common organic waste streams which contain inorganic oxides. The inorganic oxide-containing waste streams include food waste, agricultural waste, animal waste, and combinations thereof. It is a further objective of this invention to provide methods for preparing these waste streams to produce targeted batch formulations. It is yet a further objective to provide methods for melting these batch formulations to produce glasses, glass-ceramics, and ceramics.

An aspect of the invention is a method for forming a glass, glass-ceramic or ceramic utilizing organic waste materials. One aspect of the method is providing at least one organic waste material, wherein the organic waste material is inorganic oxide-containing, pretreating said at least one organic waste material, sorting said at least one organic waste material to isolate specific constituents, combining said isolated specific constituents according to a target ratio formulation of a batch formulation, melting said batch formulation to form a melt, and cooling said melt to form the glass, glass-ceramic, or ceramic material.

In one embodiment, the method may include at least one comminuting process that is performed between at least two specific processes in the method. The specific processes may include providing, preparing, sorting, combining, and melting.

In another embodiment, the method may involve at least one component that comprises particles, wherein about 100% of the particles contain at least one component of the batch formulation of a size of equal to or greater than about 5.1 mm in size, between about 1.1 mm and about 5.0 mm in size, between about 101 microns and about 1.1 mm in size, between about 11 microns and about 100 microns in size, or equal to or less than about 10 microns.

In another embodiment, the method is that the organic waste materials includes a food waste, an agricultural waste, an animal waste, a human waste, and combinations thereof. Furthermore, the organic waste may comprise at least one of an avocado peel, a nut, a used tea, a coffee grind, a lemon peel, a orange peel, a seed, a wheat husk, a potato peel, an artichoke leaf, a cotton stalk, a rice husk, a corn stover, a wheat straw, a bagasse, a peanut shell, an egg shell, a partially composted manure, a municipal solid waste, a refuse derived fuel, or any combinations thereof.

Another embodiment of the method may involve at least one incinerating process that is performed between at least two of the processes consisting of providing, preparing, sorting, combining, and melting.

Another embodiment of the method is that the target ratio of the oxides is calculated according to the target type of glass, glass-ceramic, or ceramic formulation.

A further embodiment of the method is the addition of one or more mined minerals prior to the melting step, wherein one or more the mined minerals are added to complete the mass balance of the target glass, glass-ceramic, or ceramic formulation.

Another embodiment of the method is that there may be presorting of at least one component of the glass, glass-ceramic, or ceramic batch formulation based on physical parameters such as shape, size, particle size, weight, volume, density, chemical composition, or a combination thereof. Further, at least one component of the glass, glass-ceramic, or ceramic batch formulation may be fed to a floatation unit, wherein the undesirable components sink to the bottom and are discarded and the desirable components float on the top and are retrieved. Further, at least one component of the glass, glass-ceramic, or ceramic batch formulation may be pretreated by compression, resulting in a compressed batch component or batch formulation, and at least one component of the glass, glass-ceramic, or ceramic batch formulation may be dried to remove free water from the batch formulation. Drying may be performed in air at a temperature ranging from about 60° C. to about 100° C., for durations from about 2 hours to about 48 hours. Further, at least one component of the glass, glass-ceramic, or ceramic batch formulation may be calcined, wherein the calcining is performed in air at a temperature ranging from about 400° C. to about 1,000° C., for durations from about 2 hours to about 24 hours, at least one component of the glass or ceramic, glass-ceramic, batch formulation may be washed to remove undesirable components.

A further embodiment of the method is that the melting step may involve heating said glass, glass-ceramic, or ceramic batch formulation in air ranging from about 1,000° C. to about 1,450° C., for durations from about 1 hour to about 6 hours. The method may further involve a melting step comprising heating said glass, glass-ceramic, or ceramic batch formulation in air ranging from about 1,300° C. to about 1,700° C., for durations from about 2 hours to about 6 hours.

Another embodiment of the invention may be an organic waste-containing glass, glass-ceramic, or ceramic product formed by the method.

A further embodiment of the method is that the pretreating may involve at least one of heat treating, comminuting, sieving, sorting, drying, calcining, densifying, pelletizing, washing, separating, burning, gasifying, pyrolizing, or any combinations thereof.

A further embodiment of the method is that the said combining may be performed by a computer-controlled system, where said computer-controlled system combines said isolated specific constituents into said batch formulation according to said target ratio formulation.

In another embodiment, a method for forming a glass, glass-ceramic, or ceramic material utilizing organic waste materials, comprising: providing at least one organic waste material, wherein the organic waste material is inorganic oxide-containing; pretreating said at least one organic waste material; sorting said at least one organic waste material to isolate specific constituents; combining said isolated specific constituents according to a target ratio formulation of a batch formulation; melting said batch formulation to form a melt; and cooling said melt to form the glass, glass-ceramic, or ceramic material.

In another aspect of the invention, an organic waste-containing glass, glass-ceramic, or ceramic material is formed from organic waste material, with at least about 65 mol % SiO₂, at least about 10 mol % K₂O; and at least about 9 mol % CaO.

An embodiment of the invention is that the organic waste-containing glass, glass-ceramic, or ceramic may contain at least about 5 mol % Al₂O₃, at least about 0.5 mol % MgO; and at least about 0.5 mol % P₂O₅.

An embodiment of the invention is that the organic waste-containing glass, glass-ceramic, or ceramic may contain between about 50 mol % SiO₂ and about 85 mol % SiO₂. A further embodiment of the invention is that the organic waste-containing glass, glass-ceramic, or ceramic may contain between about 65 mol % SiO₂ and about 75 mol % SiO₂. A yet further embodiment of the invention is that the organic waste-containing glass, glass-ceramic, or ceramic may contain between about 40 mol % SiO₂ and about 95 mol % SiO₂.

Another embodiment of the organic waste-containing glass, glass-ceramic, or ceramic is that it may contain at least 100% of organic waste material, and may not contain any non-organic waste material.

Another embodiment of the organic waste-containing glass, glass-ceramic, or ceramic is that it may contain at least one of a mined mineral, including a feldspar for sodium oxide, aluminum oxide, silicon oxide and calcium-oxide; a dolomite for calcium oxide and magnesium oxide; a fluorspar for calcium oxide; a limestone or a lime for calcium oxide; a potash for potassium oxide; a kyanite for alumina and silica; a sand for silica; or any combinations thereof.

In another embodiment of the invention, an organic waste-containing glass, glass-ceramic, or ceramic material formed from organic waste material, comprising: at least about 65 mol % SiO₂; at least about 10 mol % K₂O; and at least about 9 mol % CaO.

In yet another aspect of the invention, a process for manufacturing a glass, glass-ceramic, or ceramic material utilizing organic waste materials, is by providing at least one organic waste material, wherein the organic waste material is inorganic oxide-containing, pretreating said organic waste materials by calcining to isolate specific constituents, sorting said isolated specific constituents into bins which are capable of weighing and dispensing said isolated specific constituents, combining said isolated specific constituents according to a target ratio formulation of a batch formulation, melting said batch formulation to form a melt, and cooling said melt to form the glass, glass-ceramic or ceramic material.

In one embodiment of the invention, the combining may be controlled by a control system, and the control system may include a computer, and a software algorithm, where the algorithm controls the combining by sending signals to the bins that actuate the dispensing of said isolated specific constituents.

In yet another embodiment of the invention, the combining may include at least one mined mineral prior to said melting, wherein at least one of said mined minerals are added to complete the mass balance of the target ratio formulation.

In another embodiment of the invention, a process for manufacturing a glass, glass-ceramic, or ceramic material utilizing organic waste materials, comprising: providing at least one organic waste material, wherein the organic waste material is inorganic oxide-containing; pretreating said organic waste materials by calcining to isolate specific constituents; sorting said isolated specific constituents into bins which are capable of weighing and dispensing said isolated specific constituents; combining said isolated specific constituents according to a target ratio formulation of a batch formulation, melting said batch formulation to form a melt; and cooling said melt to form the glass, glass-ceramic or ceramic material.

This Summary of the Disclosure is neither intended nor should it be construed as being representative of the full extent and scope of this disclosure. Moreover, references made herein to “the present invention”, “the invention”, “the disclosure”, or aspects thereof, should be understood to mean certain embodiments and should not necessarily be construed as limiting all embodiments to a particular description. The present invention is set forth in various levels of detail in the Summary of the Disclosure as well as in the attached drawings and the Description of Embodiments and no limitation as to the scope is intended by either the inclusion or non-inclusion of elements, components, etc. in this Summary of the Invention. Additional aspects will become more readily apparent from the Description of Embodiments, particularly when taken together with the drawings.

### BRIEF DESCRIPTION OF DRAWINGS

The accompanying drawings are incorporated into and form a part of the specification to illustrate examples of how the aspects, embodiments, or configurations can be made and used and are not to be construed as limiting the aspects, embodiments, or configurations to only the illustrated and described examples. Further features and advantages will become apparent from the following, more detailed, description of the various aspects, embodiments, or configurations.

FIG. 1 illustrates a block diagram of a process for producing glasses and/or ceramics utilizing oxide containing organic waste streams.

FIG. 2 illustrates the energy dispersive x-ray spectroscopy (EDS) spectrum of calcined rice husk.

FIG. 3 illustrates the EDS spectrum of calcined eggshells.

FIG. 4 illustrates the EDS spectrum of calcined wheat husk.

FIG. 5 illustrates the EDS spectrum of calcined peanut shells.

FIG. 6 illustrates the EDS spectrum of calcined corn husk and stems.

FIG. 7 illustrates thermogravimetric analysis (TGA) curves for rice husk (7A), banana peels (7D), and egg shells (7E), and scanning electron micrograph (SEM) images of rice husk (7B), banana peels (7C), and egg shells (7F).

FIG. 8 illustrates the process going from the food waste (labeled A-E on the left side of FIG. 8) to photographs of the resulting glasses (labeled F-H on the right side of FIG. 8).

FIG. 9 illustrates XRD patterns of five glasses made using organic waste materials—the presence of broad hump-like peaks confirms the amorphous nature of these materials.

FIG. 10 illustrates dilatometric curves showing the presence of glass transformation regions in the five glasses whose XRD patterns are illustrated in FIG. 9.

FIG. 11 illustrates XRD patterns of Glass 1 as formed (bottom curve), and heat treated to about 800° C. for about 2 hours to nucleate the crystalline phase cristobalite and then at 1100° C. for 2 hour to grow the cristobalite phase (middle curve in FIG. 11).

FIG. 12 illustrates SEM images of the glass-ceramic described in FIG. 11, where discontinuous (11A, top) and continuous (11B, bottom) cristobalite crystals are observed.

FIG. 13. illustrates the phase evolution of the Leucite phase (KAlSi₂O₆) from Glass 2, following nucleation at about 800° C. for about 2 hours, and then growth at about 1100° C. for about 10 hours.

FIG. 14 illustrates the phase evolution of the Nepheline phase (KNa₃Al₄Si₄O₁₆) from Glass 3, following nucleation at about 800° C. for about 2 hours, and then growth at about 1100° C. for about 10 hours.

FIG. 15 illustrates the phase evolution of combeite (Na₆Ca₃Si₆O₁₈) for Glass 7 nucleated at about 500° C. for about 2 hours, followed by heat treatments for crystal growth at about 750° C. for about 2 and about 10 hours respectively.

### DESCRIPTION OF EMBODIMENTS

The following detailed description illustrates the invention by way of example and not by way of limitation. This description will clearly enable one skilled in the art to make and use the invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

An aspect of the present invention is a glass, glass-ceramics, or ceramic batch formulation comprising a mixture of oxide containing organic waste materials. A further aspect of the present invention is a glass, glass-ceramics, or ceramic batch formulation comprising an organic waste material comprising a food waste, an agricultural waste, an animal waste, a human waste, piggery waste, milking parlour waste, slaughterhouse waste, construction waste, demolition waste, municipal solid waste, packaging waste, post-consumer waste, yard waste, lumber waste, any other inorganic oxide-containing waste, and combinations thereof.

In some embodiments of the present invention, the organic waste materials may contain cotton stalks, rice husks, corn stover, corn husks, corn cobs, corn stems, corn leaves, broccoli stalks, wheat straw, wheat husk, wheat stem, bagasse, pine needles, pine straw, saw dust, bark, peanut shells, peanut peels, egg shells, bone material, grass husk, grass stems, artichoke material (e.g. tops and bottoms), banana peels, miscellaneous banana material (e.g. banana boil filter fiber byproduct, banana heat treated boil squeezed, and banana boil filter evaporated), sun dried tomatoes, lemon peels, lime peels, orange peels, avocado, avocado seed, potato skin, onion peels, spent beer grains, used coffee grains, cardboard products, paper products, partially composted manure, refuse derived fuel, and combinations thereof. In some further embodiments of the present invention, the organic waste materials may contain at least one of egg shell, lobster shell, snail shell, crab shell, mussel shell, shrimp shell, abalone shell, oyster shell, scallop shell, nut shell, any other high oxide content naturally occurring shell, and combinations thereof.

In some embodiments of the present invention, the glass or ceramic batch formulation may further comprise at least one mineral component. A mineral component, as used herein, may include albite feldspar, alumina, alumina hydrate, anorthite feldspar, aplite, aragonite, bone ash, barite, borax, anhydrous borax, boric acid, dolomite, caustic potash, caustic soda, cryolite, cullet, burnt dolomite, fluorspar, gypsum, kyanite, lime, limestone, litharge, microcline, nepheline, nepheline syenite, niter, potash, red lead, salt cake, sand, slag, slaked lime, soda ash, soda niter, spodumene, any other suitable metal oxide containing mineral, and combinations thereof. At least one mineral component may be needed to complete the mass balance of the glass or ceramic formulations, such that all of the essential oxides required in the formulation are attained. In other words, for a particular plant location and waste material stream availability, certain glass formulations may only be achievable with some use of standard mined mineral raw materials.

In some embodiments of the present invention, the batch formulation may be formulated to make alkali silicate glasses, alkali/alkaline earth silicate glasses, alkali and alkaline earth aluminosilicate glasses, rare earth alumino/galliosilicate glasses, lead silicate glasses, lead halosilicate glasses, alkali borate glasses, alkali aluminoborate glasses, germanate glasses, phosphate glasses, inorganic oxide glasses, halide glasses, as well as new glasses. In some further embodiments of the present invention, the batch formulation may be formulated to make alkali silicate ceramics, alkali/alkaline earth silicate ceramics, alkali and alkaline earth aluminusilicate ceramics, rare earth alumino/galliosilicate ceramics, lead silicate ceramics, lead halosilicate ceramics, alkali borate ceramics, alkali aluminoborate ceramics, germanate ceramics, phosphate ceramics, inorganic oxide ceramics, halide ceramics, as well as new ceramics.

An aspect of the present invention is a process for producing a glass or ceramic utilizing oxide containing organic waste materials, the process comprising combining at least two oxide containing organic waste materials in a targeted ratio to form a batch, and melting the batch to form a glass or ceramic.

In some embodiments of the present invention, the combined oxide containing organic waste materials may be separately stored in storage bins, from which they are metered into a weighing bin, or day bin, to form a batch. A weighing bin may comprise a vessel, container, silo, or any other suitable storage vessel. A day bin may be placed on weigh cells or a scale, wherein each batch component is weighed in to a target batch weight, one at a time, until all of the components have been added to the weighing bin, completing a batch recipe.

In some embodiments of the present invention, the batch may be melted in suitable equipment, such as an electric furnace, a cupula, a gas fired furnace, and any other suitable glass producing equipment.

In some embodiments of the present invention, the process for producing a glass or ceramic utilizing oxide containing organic waste materials may comprise at least one pretreatment step. In some embodiments of the present invention, the pretreatment step may include of heat treating, comminuting, sieving, sorting, drying, calcining, densifying, pelletizing, washing, separating, burning, gasifying, pyrolizing, and combinations thereof.

In some embodiments of the present invention, a pretreatment step may comprise sorting organic waste materials according to oxide compositions. Sorting the raw materials according to oxide content will enable easier formulation of a targeted batch to produce a glass with a specific oxide composition. The sorted materials may then be stored in storage bins. Sorting and/or separating may be achieved by particle size using sieves or screens. Sorting and/or separating may also be achieved gravimetrically.

In some embodiments of the present invention, at least one component of the glass or ceramic batch formulation, comprising an oxide containing waste material, may be pretreated by comminuting to reduce the particle size of the at least one component. Comminuting may be performed by shredding, cutting, slicing, ripping, shaving, tearing, slashing, carving, cleaving, crushing, cutting, dissevering, hacking, incising, severing, shearing, fragmenting, fraying, lacerating, grinding, or combinations thereof. In some further embodiments of the present invention, at least one component of the glass or ceramic batch formulation may be reduced in size by at least one of shredding, crushing and milling, which may include hammer milling or ball milling. Comminuting the batch may be advantageous in the downstream melting processes, wherein the increased surface area may increase the melt kinetics and facilitate better bubble removal from the melt. In some further embodiments, the final mixture comprising the complete batch formulation may be comminuted just prior to addition to the melter.

In some embodiments of the present invention, the batch formulation, or at least one component of the batch formulation, may comprise particles wherein about 100% of the particles are less than about 5.0 mm in size. In some embodiments of the present invention, the batch formulation, or at least one component of the batch formulation, may comprise particles wherein about 100% of the particles are less than about 1.0 mm in size. In some further embodiments of the present invention, the batch formulation, or at least one component of the batch formulation, may comprise particles wherein about 100% of the particles are less than about 100 microns in size. In still further embodiments of the present invention, the batch formulation, or at least one component of the batch formulation, may comprise particles wherein 100% of the particles are less than about 10 microns in size. In some embodiments, the final glass batch may comprise a heterogeneous mix of components, comprising a wide distribution of various particle sizes.

In some embodiments of the present invention, at least one component of the glass or ceramic batch formulation may be pretreated by sieving and/or sorting the components of the batch formulation based on physical parameters such as size, particle size, shape, weight, volume, density, or a combination thereof.

In some embodiments of the present invention, at least one component of the glass or ceramic batch may be pretreated by compression, resulting in a compressed batch formulation or batch component. Compressing the batch or at least one batch component results in a compressed batch material with a specific gravity and/or a specific thermal conductivity higher than that of the original material. Compressing can be accomplished by physical compression using equipment including, but not limited to, a roll press, a mechanical ram, a crammer hopper, a vacuum hopper, a progressive cavity pump, a single screw extruder, a twin-screw extruder, or combinations thereof. Compressing removes gas voids from the batch material, which is potentially beneficial in the downstream melting process by increasing melt kinetics due to the increased thermal conductivities. In some embodiments of the present invention, the batch formulation, or at least one component of the batch formulation, may be pelletized.

In some embodiments of the present invention, an organic waste material may be heat treated prior to processing in a melter. Heat treating may comprise elevating the temperature of at least one organic waste above ambient temperature, drying the at least one organic waste, calcining the at least one organic waste, and combinations thereof.

In some embodiments of the present invention, the batch formulation or at least one component of the batch formulation may be dried to remove free water from the batch. This may be done to improve energy efficiencies in a downstream melter, or to increase the capacity of a melter that is close to its design capacity. Drying may be accomplished in a convective oven, or by natural ambient airflow, or any other suitable means. In some embodiments, the batch formulation, or at least one component of the batch formulation, may be dried in a convective oven using air heating from about 60° C. to about 100° C. In some embodiments, the drying may occur from about 2 hours to about 48 hours.

In some embodiments of the present invention, the batch formulation or at least one component of the batch formulation may be calcined. In some embodiments, calcining may occur in air at a temperature ranging from about 400° C. to about 1000° C. In some embodiments, the calcination, may be in air at a temperature ranging from about 550° C. to about 1000° C. In some embodiments, the calcining may occur from about 10 hours to about 48 hours. In some embodiments, the calcining may occur from about 2 hours to about 12 hours. Shorter times may be sufficient for soft waste materials, whereas longer periods of time may be required for harder materials, for example, shell waste materials. Shorter times may be achieved by providing an oxygen rich atmosphere to the kiln. Calcining, like drying, may remove water, including both free water and hydrated water. Calcining may also cause thermal decomposition and phase transitions that remove other volatile fractions. For example, limestone may degrade to calcium oxide and carbon dioxide. Calcining may be beneficial by reducing the thermal demand on the downstream melter, and by reducing the gas that needs to be removed from the melter's molten glass, leading to a higher quality final glass product.

In some embodiments of the present invention, the batch formulation, or at least one component of the batch formulation, may be washed or cleaned to remove undesirable components. In the case of eggshells, this step may include removal of the eggshell membranes. In the case of municipal solid waste, this step may comprise the use of a “metal shark” to remove iron from the batch or a batch component. In some embodiments, an organic waste stream may be fed to a flotation unit, wherein the desirable components sink to the bottom of the unit and are retrieved, and the undesirable components float to the top and are skimmed away and discarded. In other embodiments, organic matter may be fed to a flotation unit, wherein the undesirable components sink to the bottom of the unit and are discarded, and the desirable components float to the top and are skimmed away and retrieved. In still further embodiments of the present invention, the batch or at least one component of the batch may be washed using a water spray. Undesirable water soluble or “loosely” bound, insoluble contaminants may be washed away by the water spray, yielding a cleaner more desirable batch component. Removing these components may result in a cleaner, higher quality melt, as well as reduce undesirable emissions from the melter. The water spray may include various additives, including for example, but not limited to disinfectants, biocides, antifungal components, or other additives to facilitate more hygienic treatment of waste streams such as human and animal waste streams. In some embodiments, the water and/or additives may be recovered and recycled.

In still further embodiments, at least one oxide containing organic waste stream may be burned or incinerated to remove the organic components of the waste stream, leaving behind the desirable metal oxides in the form of an ash, which may then be recovered to be used in glass or ceramic batch formulations. Heat may also be recovered from the burning and/or incineration step, wherein the recovered heat may be integrated with the melter to preheat batch components, thus improving overall process thermal efficiencies. In still further embodiments, the hot ash produced in the burner or incinerator may be fed hot and directly to the melter to increase thermal efficiencies, by eliminating or minimizing reheating requirements. In some embodiments of the present invention, the oxide containing ash from a burner or incinerator may comprise a fly ash that is collected in a bag filter, or some other dust abatement and/or capture system. In other embodiments, the oxide containing ash from the burner or incinerator may comprise a bottom ash that may be periodically removed gravimetrically from the burner or incinerator.

In some embodiments of the present invention, one oxide containing organic waste stream may be gasified or pyrolyzed to produce at least an ash stream and a syngas stream. The ash stream may be recovered and fed to either storage or directly to a melter. The syngas stream may be used to generate electricity. The electricity may be used to power an electric melter, or other device. In one embodiment of the present invention, gasification or pyrolysis is accomplished in a rotary drum device. German Patent Application Publication No. DE4341820 describes aspects of converting organic waste to energy and glass by combustion and gasification, and is incorporated herein by reference in its entirety.

In some embodiments of the present invention, the process for producing a glass or ceramic utilizing oxide containing organic waste materials may further comprise adding mineral additives to the batch to produce a composite batch comprising minerals and metal oxides from organic waste materials.

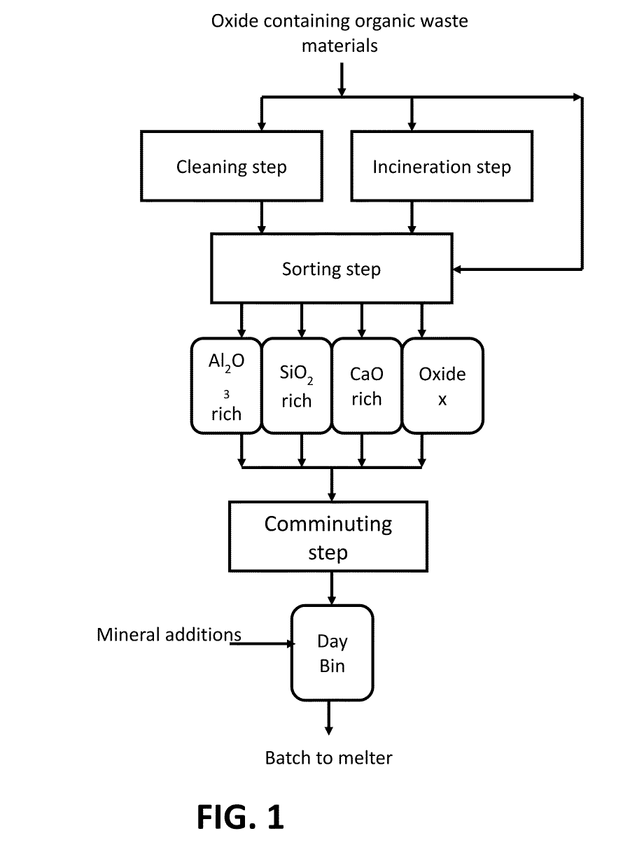

Referring now to FIG. 1, an embodiment of the present invention is illustrated in block diagram format. The first step involves receiving the various oxide containing organic waste streams; e.g. egg shells, municipal solid waste, yard waste, animal waste, etc. Upon shipment of a supply of waste material, the plant operator may decide whether or not some form of pretreatment is required before the material can be used in a particular glass batch formulation. FIG. 1 illustrates two exemplary optional pretreatment steps: a cleaning step, and an incineration step. A cleaning step may be used, for example, for the case of egg shells, which naturally contain a high concentration of calcium oxide. In this case, the cleaning step may involve removal of the egg shell protein membranes, or it may simply involve a water spray. For example, peanut shells typically comprise a significant portion of combustible organic matter. In that case, it may be desirable to pretreat this raw material stream by incinerating and burning the organic component. This step may produce heat streams which may be integrated into the overall energy balance of the glass manufacturing plant, thus improving the plant's energy efficiency. It may also result in a final solid product comprising mostly an oxide containing ash. For either case, cleaning or incineration, the resultant treated batch material may be segregated into storage silos by a sorting step. For example, the cleaned egg shells would be stored in the CaO storage silo. The ash produced by incineration of the rice husk, may be preferably stored in the SiO₂ storage silo.

Referring again to FIG. 1, the next step is a comminuting step to produce a powdered batch. It may not be necessary to comminute each of the components in the batch formulation. For example, it may only be necessary to comminute the egg shells, whereas the ash from the incinerated rice husk, may already have an acceptable particle size distribution. Regardless, each oxide required for the batch formulation may be subsequently added to the day bin, which then feeds the melter to produce the glass comprising that particular formulation of choice. This day bin, or weigh bin, may be positioned on weigh cells to facilitate easier production of an exact mass of batch material. In addition, as illustrated in FIG. 1, the batch may be further modified using non-waste streams such as conventional minerals.

Other suitable pretreatment steps could be selected depending upon the particular raw materials being processed, and the requirement of the glass melting process and physical properties of the final glass. In addition, the order of the process steps could be changed and even duplicated. For example, waste material streams may be comminuted a first time upon arrival at the glass plant. After pretreatment, at least one of the streams may be subsequently pelletized, followed by a second comminuting step. All of these various embodiments are intended to fall within the scope of the invention.

Finally, the invention may include a control system or algorithm that enables a plant operator to specify a targeted glass composition, wherein the control system or algorithm calculates the waste raw material stream amounts and ratios needed to achieve that particular glass composition. Referring again to FIG. 1, this control system could for example actuate control valves located at each of the storage silos to accurately meter in each material into the day bin, wherein the valves are closed when the weigh cells signal the controller that the correct amount of each oxide has been added to meet a particular formulation. The control system may comprise a waste raw material database that stores the oxide compositions of all of the waste streams used at the glass manufacturing plant, so that the formulation for a glass of choice, can be optimized to approximate the targeted formulation, maximize use of the waste streams, and minimize the use of conventional mineral raw material streams. The control system may take into account atmospheric conditions such as temperature and relative humidity.

All publications, patents, and patent documents cited herein are incorporated by reference herein, as though individually incorporated by reference. The invention has been described with reference to various specific and preferred embodiments and techniques. However, it should be understood that many variations and modifications may be made while remaining within the spirit and scope of the invention.

It is appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any sub-combination.

The invention now being generally described will be more readily understood by reference to the following examples, which are included merely for the purposes of illustration of certain aspects of the embodiments of the invention. The examples are not intended to limit the invention, as one of skill in the art would recognize from the above teachings and the following examples that other techniques and methods can satisfy the claims and can be employed without departing from the scope of the claimed invention.

### EXAMPLES

A mixture of different waste streams may be selected to result in a targeted final ratio of metal oxides in the final glass or ceramic formulation. The raw materials used in these experiments include rice husk (RIH), eggshells (ESH), banana peels (BNN), Corn husk/cobs (CRN), and peanut shells (PNT). The raw materials were dried at 100° C. for 24 hours, ground in a food processor blender, and pyrolized at different temperatures and times to produce the mineral compounds. The optimum pyrolization condition found was 550° C. for 15 hours. This condition can be further improved by adding oxygen or air to the furnace atmosphere during pyrolization.

Table 1 summarizes the mineral constituents in the different organic waste ash after thermal decomposition determined using x-ray fluorescence (XRF). All values listed in Table 1 are approximate.

TABLE 1
Mineral constituents in the different organic
wastes after thermal decomposition

| Waste | RIH | ESH | BNN | CRN | PNT |
|---|---|---|---|---|---|
| | Wt % | | | | |
| Ash | 19 | 57 | 2.5 | 2.0 | 1.0 |
| Component | mol % | | | | |
| SiO₂ | 98.14 | 0.10 | 7.60 | 42.27 | 33.31 |
| Al₂O₃ | 0.01 | — | 0.18 | 0.26 | 2.47 |
| Na₂O | — | 0.12 | — | 5.89 | 0.10 |
| K₂O | 0.85 | 0.04 | 50.01 | 15.26 | 18.64 |
| MgO | 0.36 | 1.13 | 2.18 | 17.39 | 11.35 |
| CaO | 0.62 | 98.49 | 3.99 | 7.33 | 26.68 |
| BaO | — | 0.05 | 0.01 | 0.01 | 0.03 |
| TiO₂ | — | — | 0.02 | — | 0.51 |
| ZrO₂ | — | 0.05 | 0.08 | — | 0.08 |
| ZnO | — | — | 0.01 | 0.20 | 0.03 |
| P₂O₅ | — | — | 1.65 | 11.28 | 3.55 |
| Fe₂O₃ | 0.02 | — | 0.07 | 0.12 | 0.55 |
| Cl | — | — | 34.20 | — | — |
| SO₃ | — | — | — | — | 2.70 |

Table 1 illustrates that various common waste materials are high in ash and more importantly, high in glass forming oxides such as silica, alumina, phosphoric oxide. In addition, many common organic waste streams also contain fluxing agents such sodium and potassium oxides.

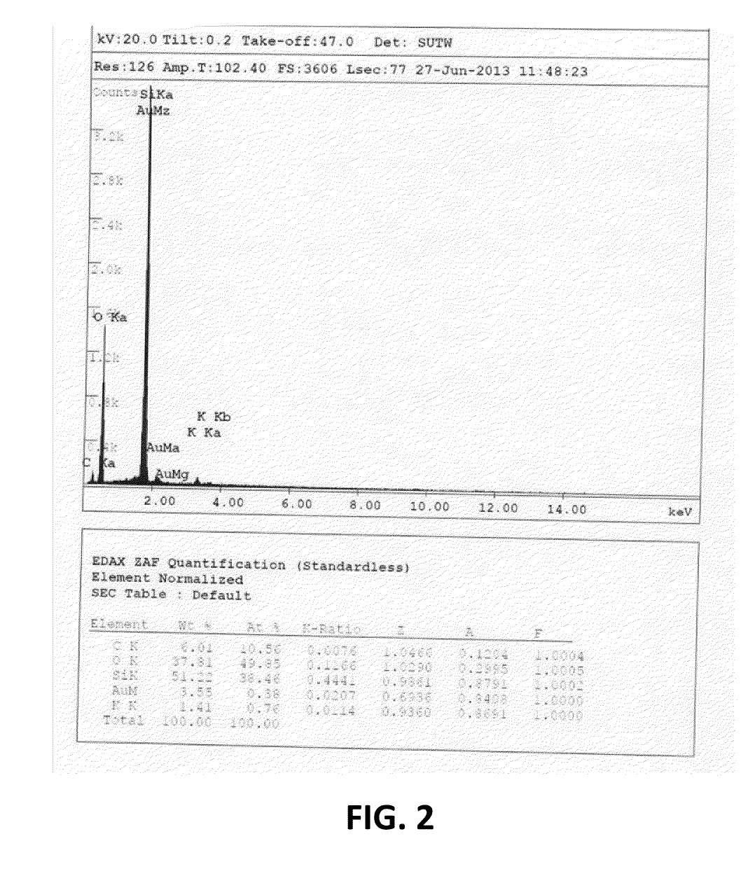

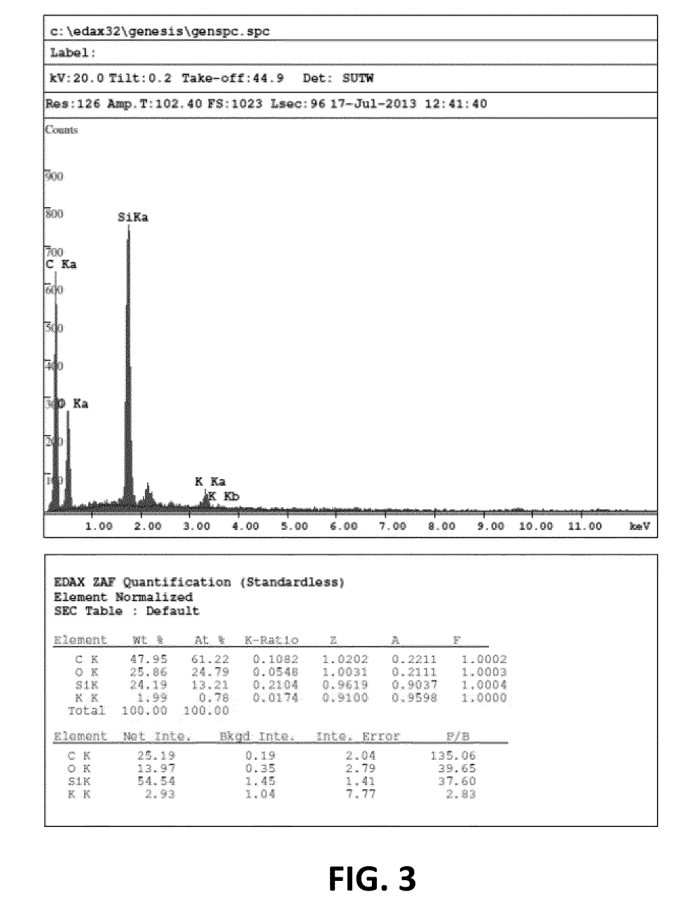

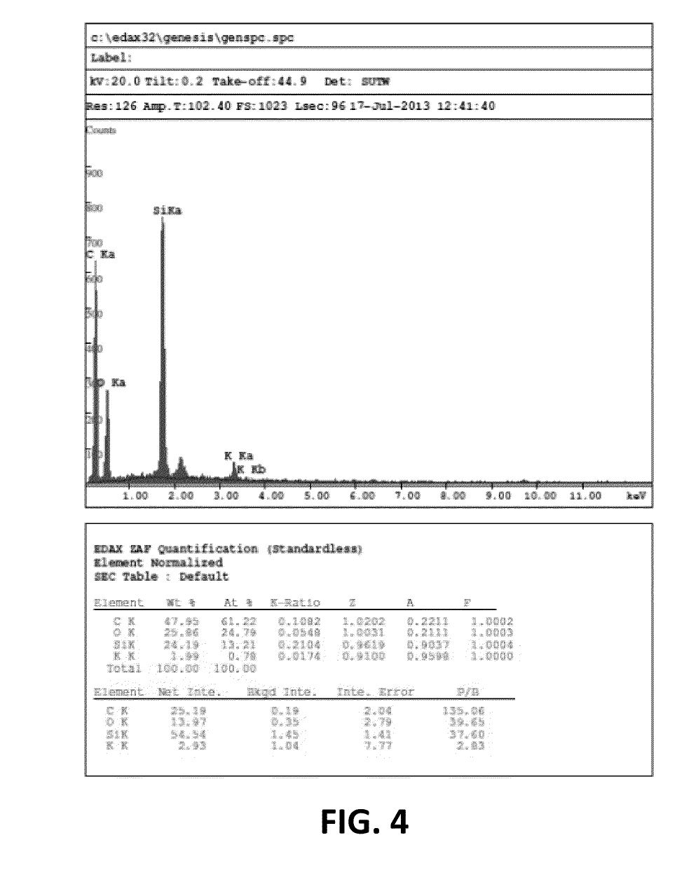

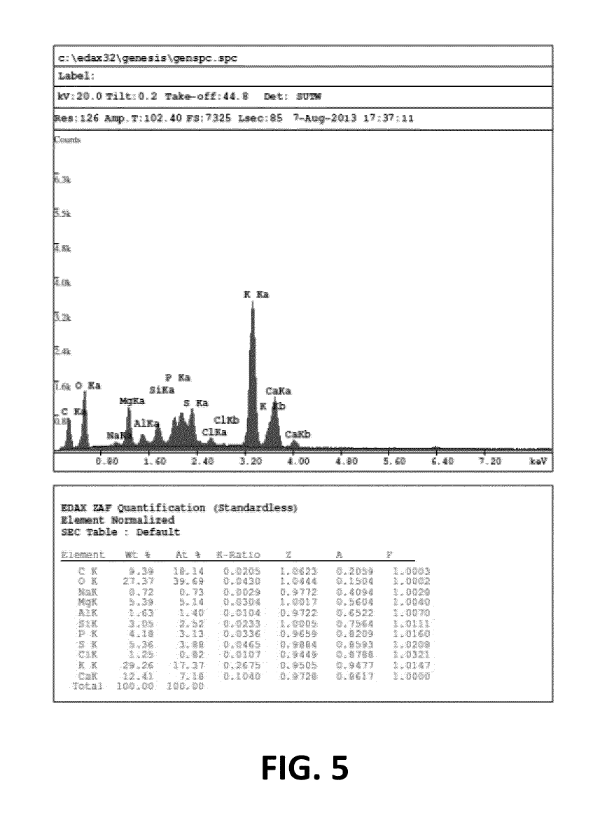

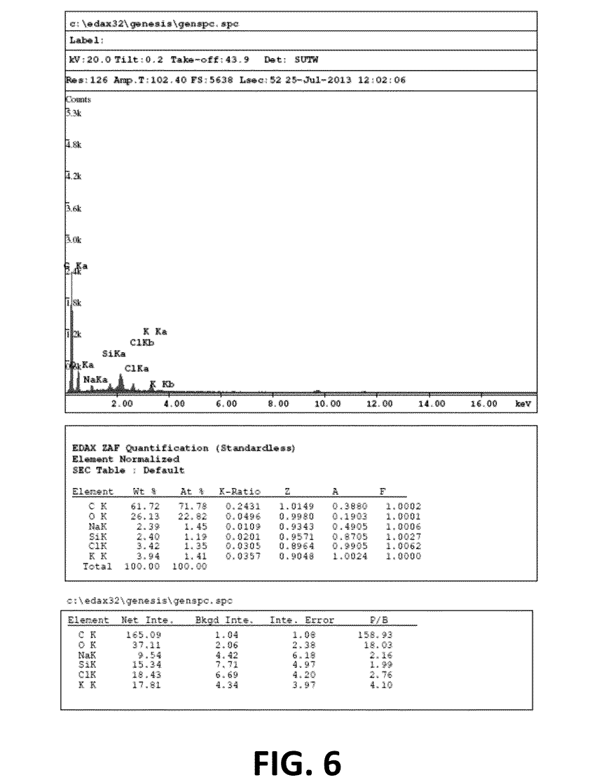

Further analysis on these powders and the precursor waste materials were done by energy dispersive x-ray spectroscopy (EDS) on several samples to measure the wt % of the elements present in the calcined products. FIG. 2 illustrates the EDS spectrum of calcined rice husk. The strong silicon (Si) peak indicates the significant presence of silica in the rice husks. FIG. 3 illustrates the EDS spectrum of calcined eggshells. The strong calcium (Ca) peak indicates the significant presence of calcium in the rice husks. FIG. 4 illustrates the EDS spectrum of calcined wheat husk. The strong silicon (Si) peak indicates the significant presence of silica in the wheat husks. FIG. 5 illustrates the EDS spectrum of calcined peanut shells. The strong potassium (Ka) peak indicates the significant presence of potassium in the peanut shells. Peaks from calcium, magnesium, silicon and aluminum indicates those metal oxides are also present in the calcined peanut shells. FIG. 6 illustrates the EDS spectrum of calcined corn husk and stems, calcined wheat husk, calcined peanut shells, and, respectively.

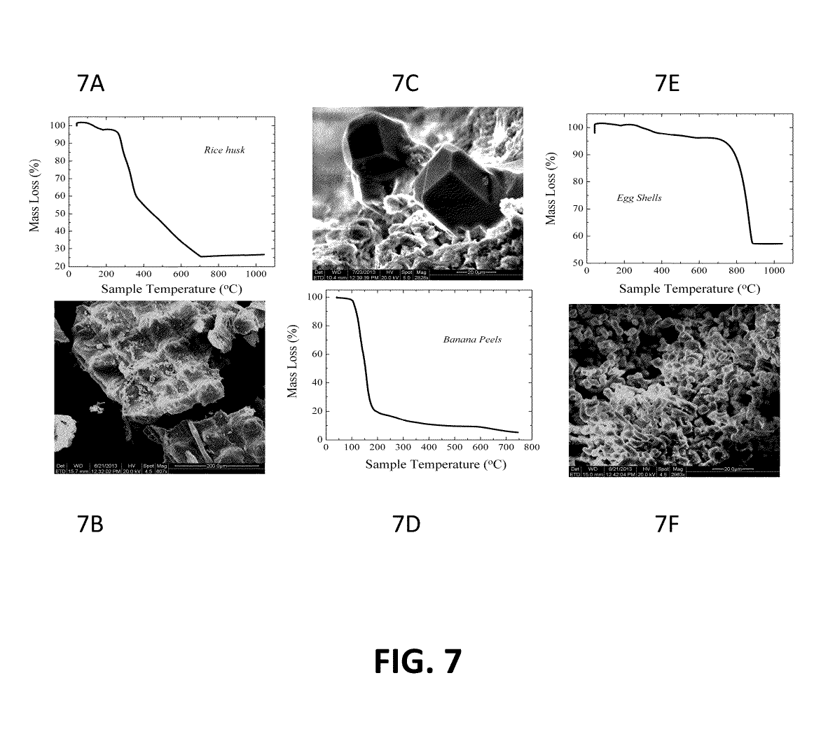

The process of pyrolization drives off water, oils, gases, and finally CO₂. Thermogravimetric analysis (TGA) follows change in weight of the waste material as a function of temperature. TGA curves for rice husk (7A), babanana peels (7D), and egg shells (7E), and scanning electron micrograph (SEM) images rice husk (7B), babanana peels (7C), and egg shells (7F) are illustrated in FIG. 7

### Example 1

### Exemplary Glass Compositions

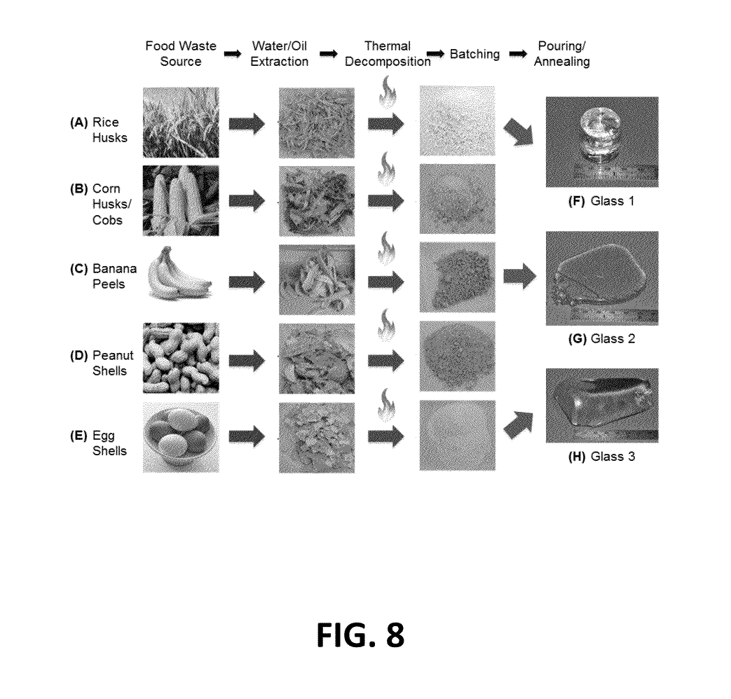

Table 2 illustrates five exemplary glass compositions that were manufactured by the invention, and the final compositions analyzed by XRF. All values listed in Table 2 are approximate. Glass 1 resembles a typical soda-lime tableware glass composition. In addition to rice husk and egg shells, sodium chloride (as table salt) and alumina powder were added to obtain the soda-lime glass composition. Glass 2 is a calcium-potassium silicate glass composition that was made using only rice husk, egg shells, and banana peels, and does not contain any commercial additives mined and extracted from conventional sources. Glass 3 is a generic multicomponent, ion-exchangeable glass system that was produced using multiple sources of organic waste as raw materials: rice husk, eggshells, peanuts shells and membranes, and corn husk and cobs. Glass 4 is also a generic ion-exchangeable potassium-sodium alumino silicate multicomponent glass with alumina and NaCl additions from mined Al₂O₃ and table salt. Glass 7 is a bio-compatible glass made by rice husk, peanut shells, eggshells, and corn husks and cobs. Sodium was also added as table salt. FIG. 8 provides an illustration of the process going from the food waste (labeled A-E on the left side of FIG. 8) to photographs of the resulting glasses (labeled F-H on the right side of FIG. 8). Glass 1, Glass 2, and Glass 3 are shown in FIG. 8F, FIG. 8G, and FIG. 8H, respectively. The invention is not limited to these compositions and can be applied to any other glass, glass-ceramic, and ceramic formulation. Other examples include, but are not limited to vitreous silica, alkali and alkaline earth aluminosilicates, lead silicates, lead halosilicates, alkali borates, alkali aluminoborates, alkali borosilicates, germanate glasses, phosphate glasses, and inorganic oxide glasses.

The glass compositions in Table 2 were then calculated using a batch calculator created by the inventor where the mineral content of the wastes and the yielded ash content of the waste are used as predetermined factors. For example, about a 100 g sample of rice husk will yield about 19 g of ash after calcination. This 19 g will yield about 18.65 g of SiO₂, about 0.16 g of K₂O, about 0.07 g of MgO, and about 0.12 g of CaO. Fe₂O₃ and Al₂O₃ in this ash will be about 3.8 and about 1.9 μg, respectively.

TABLE 2
Glass Compositions of each glass

| | | | | | |
|---|---|---|---|---|---|
| Oxide | Glass 1 | Glass 2 | Glass 3 | Glass 4 | Glass 7 |

mol %

| | | | | | |
|---|---|---|---|---|---|
| SiO₂ | 81.34 | 68.43 | 63.97 | 78.05 | 46.05 |
| Al₂O₃ | 1.71 | 7.67 | 5.44 | 1.95 | 2.09 |
| Na₂O | 7.92 | 0.00 | 15.89 | 9.26 | 18.59 |
| K₂O | 0.27 | 11.30 | 5.95 | 6.87 | 2.17 |
| MgO | 0.45 | 0.97 | 3.36 | 0.46 | 1.59 |
| CaO | 8.28 | 10.60 | 3.51 | 2.66 | 26.30 |
| BaO | 0.01 | 0.00 | 0.00 | 0.00 | 0.00 |
| TiO₂ | 0.00 | 0.00 | 0.00 | 0.00 | 0.02 |
| ZrO₂ | 0.00 | 0.00 | 0.01 | 0.00 | 0.00 |
| ZnO | 0.00 | 0.00 | 0.03 | 0.01 | 0.01 |
| P₂O₅ | 0.00 | 0.97 | 1.67 | 0.62 | 3.07 |
| Fe₂O₃ | 0.02 | 0.06 | 0.07 | 0.01 | 0.05 |
| MnO₂ | 0.00 | 0.00 | 0.11 | 0.12 | 0.07 |

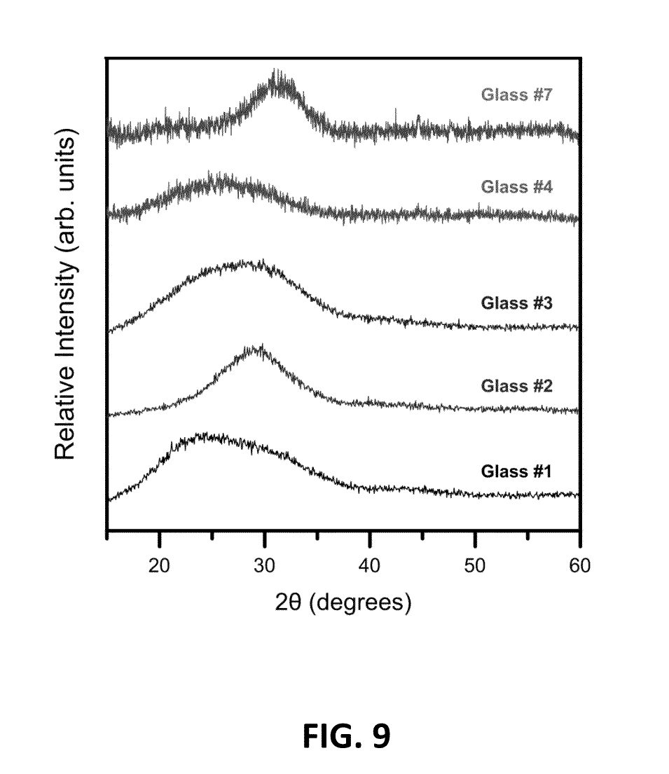

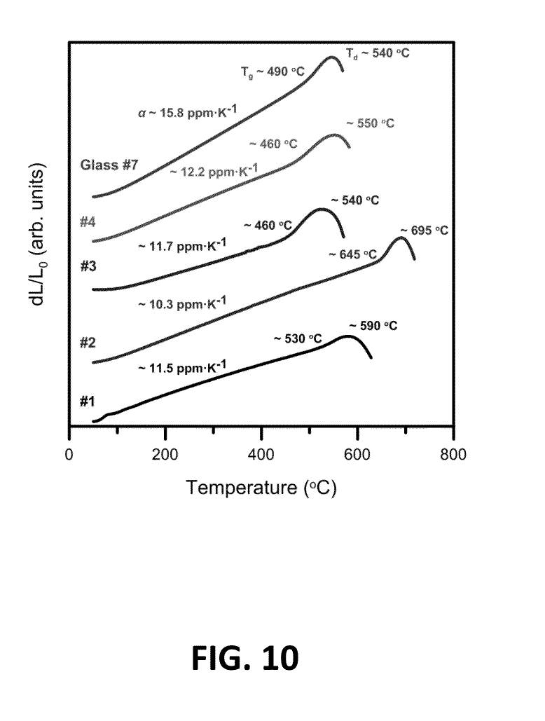

FIG. 9 illustrates the XRD patterns of the glass compositions in Table 2. The XRD patterns show broad peaks (humps), confirming the samples are amorphous. Concurrently, dilatometry was used to determine the glass transition regions and coefficients of thermal expansion (CTE) for the same glasses, as displayed in FIG. 10. The dilatometry curves of the five glass specimens from room temperature to about 650°-750° C. are illustrated in FIG. 10. The glass transformation regions, including the glass transition temperature, T_{g}, and the dilatometric softening point, T_{d} (corresponding approximately to melt viscosities of 10^{11.3} and 10⁸-10⁹ Pa-s, respectively), for each glass are also indicated. The CTE values represent linear quantities calculated by averaging the expansion from room temperature to about 300° C. These results, together with the XRD analysis, confirm unequivocally that the materials produced are glasses.

### Exemplary Glass-Ceramic Compositions

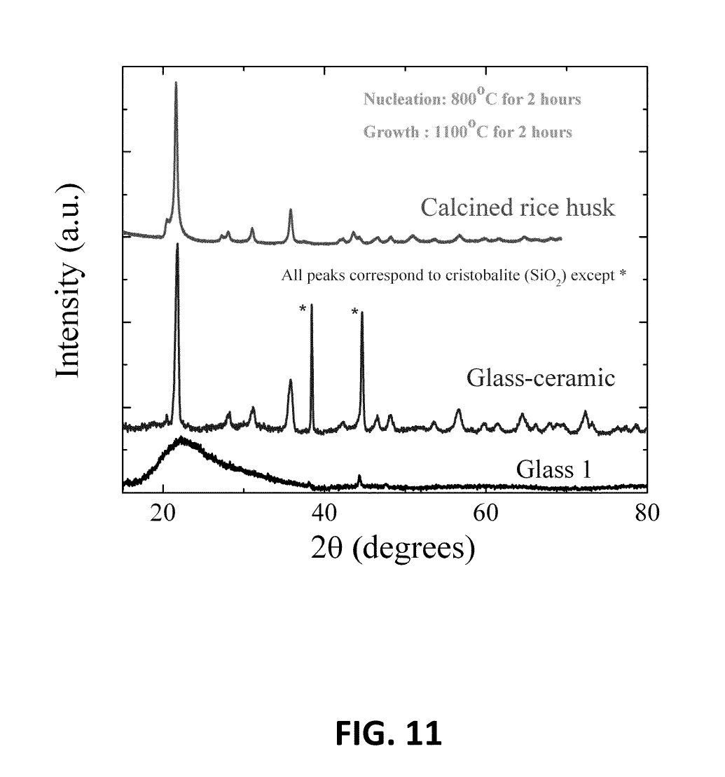

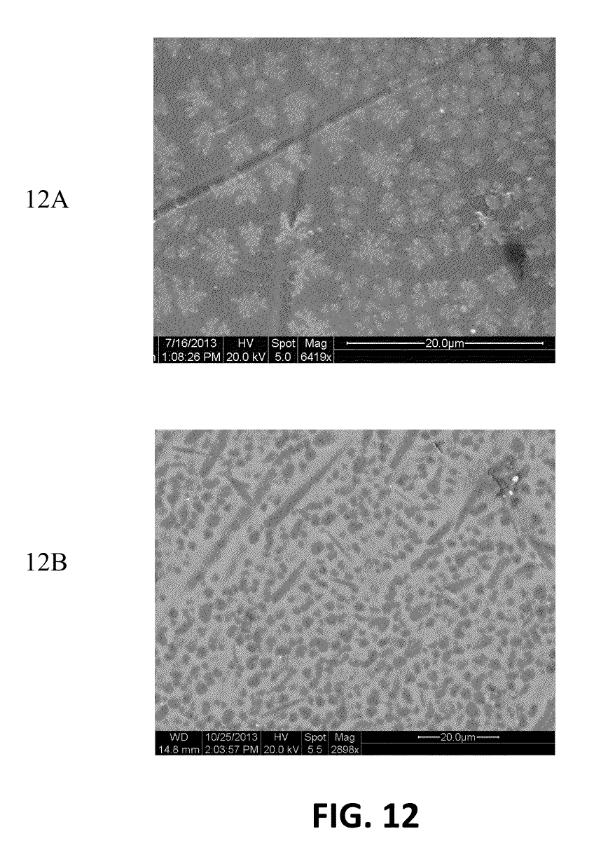

The glass compositions of Glass 1, Glass 2, Glass 3, and Glass 7 of FIG. 8, FIG. 9, and Table 2 were heat treated at different temperatures and times to create polycrystalline “ceramics” derived from their parent glasses—a glass-ceramic. FIG. 11 illustrates the XRD patterns of Glass 1 as formed (bottom curve), and heat treated to about 800° C. for about 2 hours to nucleate the crystalline phase cristobalite and then at about 1100° C. for about 2 hour to grow the cristobalite phase (middle curve in FIG. 11). The upper pattern in FIG. 11 is presented as a comparison to crystallized (ceramic) rice husk for comparison. FIG. 12 illustrates SEM images of the glass-ceramic where discontinuous (11A, top) and continuous (11B, bottom) cristobalite crystals are observed.

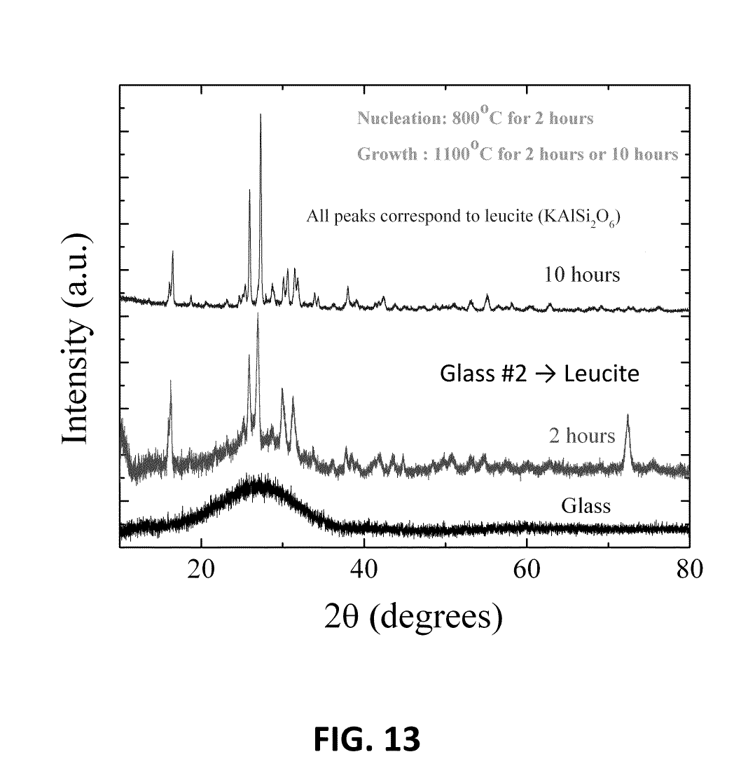

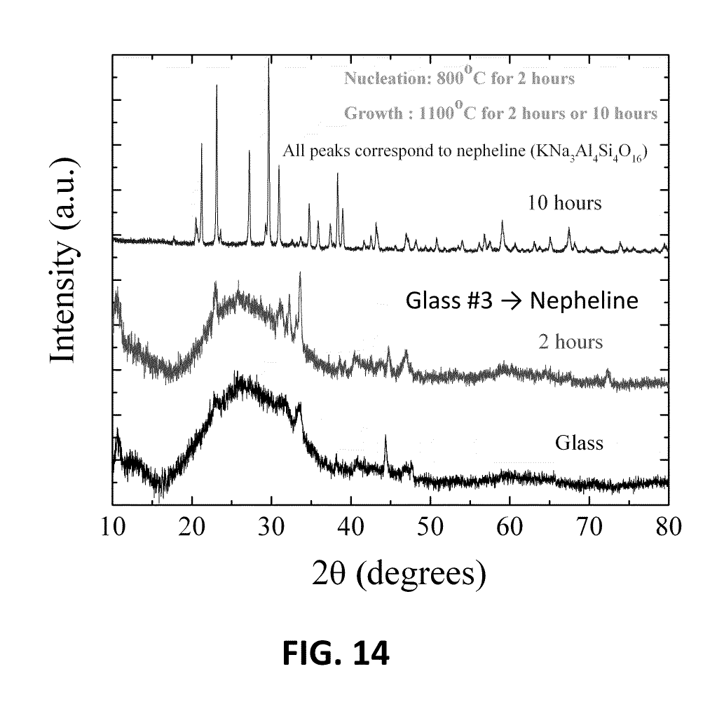

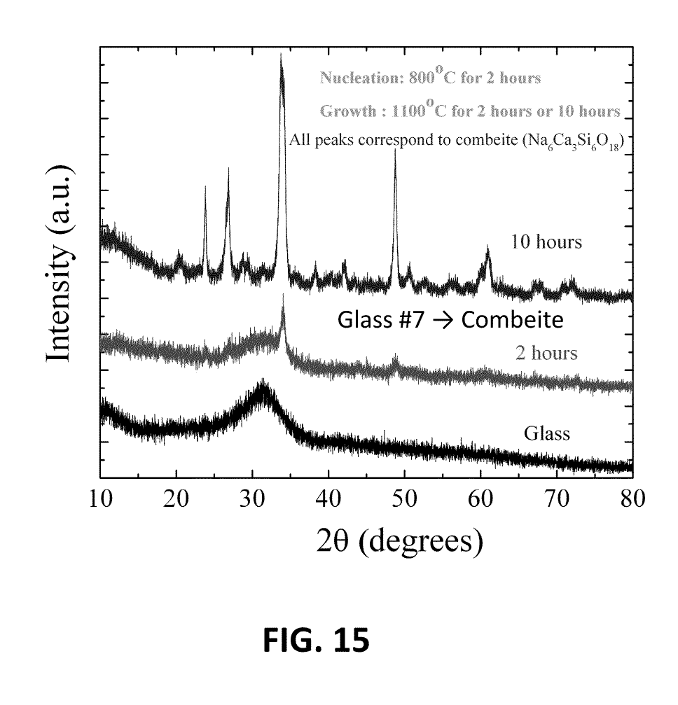

FIGS. 13 and 14 illustrate the phase evolution of the Leucite phase (KAlSi₂O₆) from Glass 2, and the Nepheline phase (KNa₃Al₄Si₄O₁₆) from Glass #3, respectively. Both phases were nucleated at 800° C. for 2 hours and growth at 1100° C. for 10 hours. FIG. 15 shows the phase evolution of combeite (Na₆Ca₃Si₆O₁₈) for Glass #7 nucleated at 500° C. for two hours followed at heat treatments for crystal growth at 750° C. for 2 and 10 hours respectively. The invention is not limited to these compositions and can be applied to any other glass-ceramic assemblage.

The glass ceramics developed in these invention can be further crystallized to a 100% ceramic body by increasing either the heat treatment temperatures or holding times. However, by simple heat-treatments of the inorganic oxides, unique crystals or ceramic systems can be achieved. For example, FIG. 7C shows an SEM image of KCl crystals developed from banana peels at 800° C. for 10 hours in an alumina crucible. The faceted crystal of about 20 μm can be easily observed in the image.

The foregoing description of the invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the invention. The embodiment described hereinabove is further intended to explain the best mode known for practicing the invention and to enable others skilled in the art to utilize the invention in such, or other, embodiments and with various modifications required by the particular applications or uses of the invention. It is intended that the appended claims be construed to include alternative embodiments to the extent permitted by the prior art.

What is claimed is:

1. A method for forming a glass, glass-ceramic, or ceramic material utilizing organic waste materials, comprising:
providing at least one organic waste material, wherein the organic waste material is inorganic oxide-containing;
pretreating said at least one organic waste material;
sorting said at least one organic waste material to isolate specific constituents;
combining said isolated specific constituents according to a target ratio formulation of a batch formulation;
melting said batch formulation to form a melt; and
cooling said melt to form the glass, glass-ceramic, or ceramic material.

2. The method of claim 1, further comprising at least one comminuting process that is performed between at least two steps.

3. The method of claim 1, wherein about 100% of particles of the isolated specific constituents has a size range, wherein the size range is selected from a group consisting of equal to or greater than about 5.1 mm in size, between about 1.1 mm and about 5.0 mm in size; between about 101 microns and about 1.0 mm in size; between about 11 microns and about 100 microns in size; and sizes equal to or less than 10 microns.

4. The method of claim 1, wherein said at least one organic waste materials comprise a food waste, an agricultural waste, an animal waste, a human waste, or any combinations thereof.

5. The method of claim 1, wherein said at least one organic waste materials comprise at least one of an avocado peel, a nut, a used tea, a coffee grind, a lemon peel, a orange peel, a seed, a wheat husk, a potato peel, an artichoke leaf, a cotton stalk, a rice husk, a corn stover, a wheat straw, a bagasse, a peanut shell, an egg shell, a partially composted manure, a municipal solid waste, a refuse derived fuel, or any combinations thereof.

6. The method of claim 1, further comprising at least one incinerating process that is performed between at least two of the steps.

7. The method of claim 1, wherein said target ratio is calculated according to a target type of glass, glass-ceramic, or ceramic batch formulation.

8. The method of claim 1, further comprising adding at least one mined mineral prior to the melting process, wherein at least one of said mined minerals are added to complete the mass balance of a target ratio formulation of the glass, glass-ceramic, or ceramic batch formulation.

9. The method of claim 1,
wherein at least one isolated specific constituent of the glass, glass-ceramic, or ceramic batch formulation is presorted based on physical parameters such as a shape, a particle size, a weight, a volume, a density, or any combination thereof;
wherein the isolated specific constituent is comprised of desirable components and undesirable components, wherein at least one isolated specific constituent of the glass, glass-ceramic, or ceramic batch formulation is fed to a floatation unit, wherein the undesirable components sink to the bottom and are discarded, and the desirable components float on the top and are retrieved;
wherein at least one isolated specific constituent of the glass, glass-ceramic, or ceramic batch formulation is pretreated by compression resulting in a compressed isolated specific constituent;
wherein at least one isolated specific constituent of the glass, glass-ceramic, or ceramic batch formulation is dried to remove free water, and wherein the drying is performed in air at a temperature ranging from about 60° C. to about 100° C., for durations from about 2 hours to about 48 hours;
wherein at least one isolated specific constituent of the glass, glass-ceramic, or ceramic batch formulation is calcined, and wherein the calcining is performed in air at a temperature ranging from about 400° C. to about 1000° C., for durations from about 2 hours to about 15 hours; and
wherein the isolated specific constituent is comprised of desirable components and undesirable components, wherein at least one isolated specific constituent of the glass, glass-ceramic, or ceramic batch formulation is washed to remove undesirable components.

10. The method of claim 1, wherein said melting comprises heating said glass, glass-ceramic, or ceramic batch formulation in air at temperatures ranging from about 1,000° C. to about 1,450° C., for durations from about 2 hours to about 6 hours.

11. The method of claim 1, wherein said pretreating comprises at least one of heat treating, comminuting, sieving, sorting, drying, calcining, densifying, pelletizing, washing, separating, burning, gasifying, pyrolizing, or any combinations thereof.

12. The method of claim 1,
wherein said combining is performed by a computer-controlled system, and
wherein said computer-controlled system combines said isolated specific constituents into said batch formulation according to said target ratio formulation.

13. An organic waste-containing glass, glass-ceramic, or ceramic material formed from organic waste material, comprising:
at least about 50 mol % SiO₂;
at least about 10 mol % K₂O; and
at least about 9 mol % CaO.

14. The organic waste-containing glass, glass-ceramic, or ceramic material of claim 13, further comprising:
at least about 2 mol % Al₂O₃;
at least about 0.5 mol % MgO; and
at least about 0.5 mol % P₂O₅.

15. The organic waste containing glass or ceramic of claim 14:
wherein said glass, glass-ceramic, or ceramic material comprises 100% of organic waste material; and
wherein said glass, glass-ceramic, or ceramic material contains no non-organic waste material.

16. The organic waste containing glass, glass-ceramic, or ceramic of claim 13, further comprising at least one of a mined mineral, including a feldspar for sodium oxide, aluminum oxide, silicon oxide and calcium-oxide; a dolomite for calcium oxide and magnesium oxide; a fluorspar for calcium oxide; a limestone or a lime for calcium oxide; a potash for potassium oxide; a kyanite for alumina and silica; a sand for silica; or any combinations thereof.

17. A process for manufacturing a glass, glass-ceramic, or ceramic material utilizing organic waste materials, comprising:
providing at least one organic waste material, wherein the organic waste material is inorganic oxide-containing;
pretreating said organic waste materials by calcining to isolate specific constituents;
sorting said isolated specific constituents into bins which are capable of weighing and dispensing said isolated specific constituents;
combining said isolated specific constituents according to a target ratio formulation of a batch formulation,
melting said batch formulation to form a melt; and
cooling said melt to form the glass, glass-ceramic or ceramic material.

18. The process of claim 17, wherein said combining is controlled by a control system.

19. The process of claim 18, wherein said control system comprises:
a computer; and
a software algorithm, wherein said algorithm controls the combining by sending signals to the bins that actuate the dispensing of said isolated specific constituents.

20. The process of claim 17, further comprising combining at least one mined mineral prior to said melting, wherein at least one of said mined minerals are added to complete the mass balance of the target ratio formulation.
